(19) United States
(12) Patent Application Publication
(10) Pub. No.: US 2010/0030877 A1
(43) Pub. Date: Feb. 4, 2010

(54) VIRTUAL SERVER SYSTEM AND PHYSICAL SERVER SELECTING METHOD

(76) Inventor: Mitsuru Yanagisawa, Tokyo (JP)

Correspondence Address: FOLEY AND LARDNER LLP;SUITE 500, 3000 K STREET NW, WASHINGTON, DC, 20007, US

(21) Appl. No.: 12/449,481

(22) PCT Filed: Feb. 18, 2008
(86) PCT No.: PCT/JP2008/052679

§ 371 Date: Aug. 11, 2009

(30) Foreign Application Priority Data
Feb. 23, 2007 (JP) 2007-043563

(51) Int. Cl. G06F 15/177; G06F 15/173

(52) U.S. Cl. 709/221; 709/226

(57) ABSTRACT

By using resource information of a physical server and a virtual server and capacity information of the physical server, a virtual server system and a physical server selecting method extract a physical server in which the utilization rate of resources is more than a high load threshold value or lower than a low load threshold value; with respect to moving candidates comprised of all combinations of a plurality of operating virtual servers in the extracted physical servers and physical servers to where the virtual servers move, seek an evaluation value of an index to level the utilization rate of resources for each server after virtual servers move; determine virtual servers are to be moved, original physical servers and destination physical servers to where virtual servers are to be moved in accordance with the evaluation value; and move the determined virtual servers to the destination physical servers.

### TECHNICAL FIELD

The present invention relates to a virtual server system capable of operating a plurality of virtual servers on a plurality of physical servers at the same time and a physical server selecting method.

### BACKGROUND ART

In recent years, a virtual server technology for constituting a plurality of virtual servers on one physical server by using software and executing a plurality of processes with the virtual servers at the same time has been realized. According to the virtual server technology, it is also possible to constitute a system for simultaneously operating a plurality of virtual servers on a plurality of physical servers connected with a communication network.

In the virtual server system in which the virtual servers operate on the physical servers, the following technology has been conventionally known: when the utilization rate of resources of the physical server exceeds a high load threshold that is the preset upper limit, the virtual servers that operate on the corresponding physical server are moved to other physical servers in which the utilization rate of resources is relatively low, so that the utilization rates of resources of the respective physical servers are distributed.

For example, Japanese Patent Laid-Open No. 2005-115653 discloses the following: data of the memory capacity of each physical server, data of the memory capacity that is used in each virtual server and measurement data of performance of each virtual server for every predetermined time are obtained from a management server that manages the virtual server system, and the virtual servers are disposed on the respective physical servers so that a summation of values indicating the performances of the respective virtual servers is a maximum value.

However, in the conventional virtual server system as described above, although it is realized that the virtual servers, which operate on the physical server in which the utilization rate of resources is higher, are moved to the other physical servers to distribute the utilization rate of resources of each physical server, no thought is given to leveling the utilization rate of resources of the original physical servers and the destination physical servers to where the virtual servers move.

For example, in the virtual server system disclosed in the Japanese Patent Laid-Open No. 2005-115653, since the lower limit of performance of the virtual server is preset, when the virtual servers are allotted to the physical servers based on the lower limit of performance, a deviation may be generated in the utilization rates of resources of the respective physical servers and an idle resources may be generated in any physical server.

Similarly, the conventional virtual server system does not contemplate disposing virtual servers on respective physical servers so that they can operate more efficiently, such as leveling the utilization rate of resources, and such as optimizing the concentration of resource utilization rate of the physical server having a lower load so as to improve utilization efficiency of the sever and the like.

### SUMMARY

Accordingly, an object of the invention is to provide a virtual server system capable of disposing a plurality of virtual servers on each physical server so that they can operate most effectively, and a physical server selecting method.

In order to achieve the above object, there is provided a virtual server system comprising:

a plurality of physical servers on each of which a plurality of virtual servers operate; and

an autonomous control server that is connected to the physical servers by a communication network,

wherein the autonomous control server extracts a physical server in which the utilization rate of resources exceeds a high load threshold value by using resource information of the physical servers and the virtual servers and capacity information of the physical servers, the capacity information indicating a performance value of the physical server and the high load threshold value being the preset upper limit of a utilization rate of resources for each resource;

with respect to moving candidates comprised of all combinations of a plurality of virtual servers operating on the extracted physical server and physical servers to where the virtual servers move, calculates an evaluation value that is an index to level the utilization rates of resources of each physical server after preset virtual servers move;

determines a virtual server, that is to be moved and a destination physical server thereof to where the virtual sever moves, from the moving candidate having the lowest evaluation value; and

moves the determined virtual server to the destination physical server.

Alternatively, there is provided a virtual server system comprising:

a plurality of physical servers on each of which a plurality of virtual servers operate; and

an autonomous control server that is connected to the physical servers by a communication network,

wherein the autonomous control server extracts a physical server in which a utilization rate of resources is lower than a low load threshold value by using resource information of the physical servers and the virtual servers and capacity information of the physical servers, the capacity information indicating a performance value of the physical server and the low load threshold value being the preset lower limit of a utilization rate of resources for each resource;

with respect to moving candidates comprised of all combinations of a plurality of virtual servers to be moved to the extracted physical server and original physical servers to where the virtual servers are to be moved, calculates an evaluation value that is an index to level the utilization rates of resources of each physical server after preset virtual servers move;

determines a virtual server to be moved and an original physical server thereof to where the virtual server is to be moved from the moving candidate having the highest evaluation value; and

moves the virtual server from the determined original physical server.

In the meantime, there is provided a method of selecting a physical server on which a plurality of virtual servers are disposed, wherein a computer:

extracts a physical server in which a utilization rate of resources exceeds a high load threshold value by using resource information of the physical server and the virtual servers and capacity information of the physical server, the capacity information indicating a performance value of the physical server and the high load threshold value being the preset upper limit of a utilization rate of resources for each resource;

with respect to moving candidates comprised of all combinations of a plurality of virtual servers operating on the extracted physical server and physical servers to where the virtual servers move, calculates an evaluation value that is an index to smooth the utilization rates of resources of each physical server after preset virtual servers move;

determines a virtual server to be moved and a destination physical server thereof to where the virtual sever moves from the moving candidate having the lowest evaluation value; and

moves the determined virtual server to the destination physical server.

Alternatively, there is provided a method of selecting a physical server on which a plurality of virtual servers are disposed, wherein a computer:

extracts a physical server in which a utilization rate of resources is lower than a low load threshold value by using resource information of the physical server and the virtual servers and capacity information of the physical server, the capacity information indicating a performance value of the physical server and the low load threshold value being the preset lower limit of a utilization rate of resources for each resource;

with respect to moving candidates comprised of all combinations of a plurality of virtual servers to be moved to the extracted physical server and original physical servers to where the virtual servers are to be moved, calculates an evaluation value that is an index to level the utilization rates of resources of each physical server after preset virtual servers move;

determines a virtual server to be moved and an original physical server thereof to where the virtual server is to be moved from the moving candidate having the highest evaluation value; and

moves the virtual server from the determined original physical server.

### BRIEF DESCRIPTION OF THE DRAWINGS

[FIG. 1]

FIG. 1 is a block diagram showing an example of a structure of a virtual server system according to an exemplary embodiment of the invention.

[FIG. 2]

FIG. 2 is a block diagram showing an example of realizing an autonomous control server shown in FIG. 1.

[FIG. 3]

FIG. 3 is a flow chart showing procedures of a first exemplary embodiment of an autonomous control server provided to the virtual server system shown in FIG. 1.

[FIG. 4]

FIG. 4 schematically shows that utilization rates of resources of each physical server are changed before and after a virtual server is moved.

### EXEMPLARY EMBODIMENT

Hereinafter, the invention will be described with reference to the drawings.

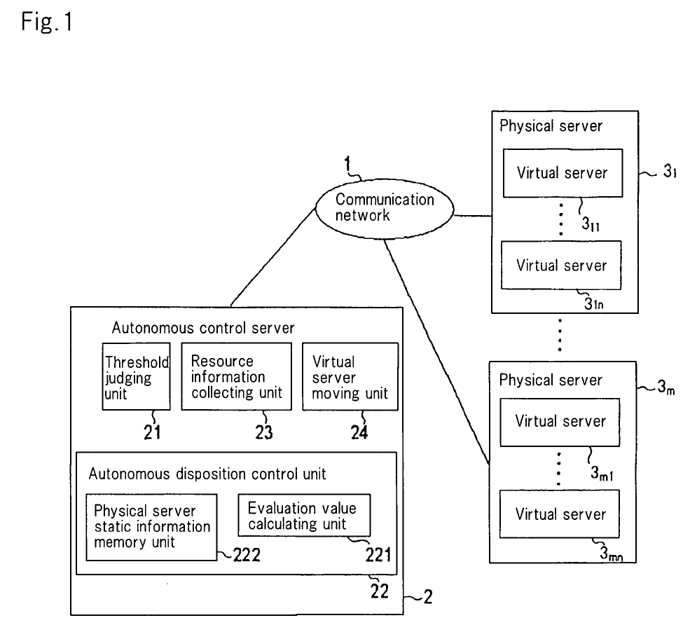

FIG. 1 is a block diagram showing an example of a structure of a virtual server system according to an exemplary embodiment of the invention.

As shown in FIG. 1, a virtual server system of the invention comprises a plurality of physical servers 3₁˜3ₘ (m: positive number) and autonomous control server 2 that manages each of virtual servers that operate on physical servers 3₁˜3ₘ. Autonomous control server 2 and physical servers 3₁˜3ₘ are connected via communication network 1. In FIG. 1, the virtual servers that operate on physical server 3₁ are denoted as 3₁₁˜3₁ₙ and the virtual servers that operate on physical server 3ₘ are denoted as 3ₘ₁˜3ₘₙ. (n: positive number).

Physical servers 3₁˜3ₘ are realized by computers each of which executes processes in accordance with a program stored in a recording medium (magnetic disc, semiconductor memory, optical disc and the like), for example.

Autonomous control server 2 has resource information collecting unit 23, threshold judging unit 21, autonomous disposition control unit 22 and virtual server moving unit 24.

Resource information collecting unit 23 obtains, from physical servers 3₁˜3ₘ and virtual servers 3₁₁˜3ₘₙ, resource information such as the CPU utilization rate of each server, memory utilization rate, input/output performance value of a recording medium (for example, the ratio of input/output data transfer rate to maximum data transfer rate), the input/output performance value of a communication control apparatus (transfer rate, utilization band and the like) and the like.

Threshold judging unit 21 compares the resource utilization rates of physical servers 3₁˜3ₘ and virtual servers 3₁₁˜3ₘₙ with a high load threshold value, which is the preset upper limit of the utilization rate for each resource, or a low load threshold value, which is the preset lower limit thereof, based on the resource information obtained from resource information collecting unit 23, to extract information of a physical server in which the utilization rate of resources exceeds the high load threshold value, or a physical server in which the utilization rate of resources is lower than the low load threshold value, and notifies autonomous disposition control unit 22 of the information of the corresponding physical server.

Autonomous disposition control unit 22 has physical server static information memory unit 222 and evaluation value calculating unit 221.

Physical server static information memory unit 222 stores capacity information (clock frequency of CPU, memory capacity, maximum transfer rate of a hard disk drive and the like), which is a performance value of each of physical servers 3₁˜3ₘ, which are management objects.

Evaluation value calculating unit 221 calculates, with respect to moving candidates comprised of all combinations of a plurality of virtual servers that operate on the physical server notified from threshold judging unit 21 and other physical servers that are the destination servers to where virtual servers move, evaluation values by using the resource information of physical servers 3₁˜3ₘ and virtual servers 3₁₁˜3ₘₙ, which is obtained from resource information collecting unit 23, and the capacity information of the physical servers stored in physical server static information memory unit 222. The evaluation value is an index to optimize (level) the utilization rates of resources of the respective physical servers after the virtual servers move. In addition, evaluation value calculating unit 221 determines virtual servers to be moved and physical servers to where the virtual servers move, based on the evaluation values calculated, and outputs to virtual server moving unit 24 information regarding the determined virtual servers that are to be moved and the destination physical servers to where the virtual servers move.

Virtual server moving unit 24 moves the virtual servers determined by evaluation value calculating unit 221 to the destination physical servers.

Autonomous control server 2 is realized by a computer, for example, and has processing apparatus 10 that executes a predetermined process in accordance with a program, input apparatus 20 with which a command, information and the like are inputted to processing apparatus 10, and output apparatus 30 that monitors a process result of processing apparatus 10.

Processing apparatus 10 has CPU 11, main memory apparatus 12 that temporarily stores information necessary for a process of CPU 11, recording medium 13 in which a program to enable CPU 11 to execute a process as autonomous control server 2 is recorded, data accumulating apparatus 14 in which the resource information of physical servers 3₁˜3ₘ and virtual servers 3₁₁˜3ₘₙ, the capacity information of physical servers 3₁˜3ₘ and the like are stored, memory control interface unit 15 that controls data transfer with main memory apparatus 12, recording medium 13 and data accumulating apparatus 14, I/O interface unit 16 that is an interface apparatus with input apparatus 20 and output apparatus 30, and communication control apparatus 17 that is an interface with communication network 1. CPU 11, memory control interface unit 15, I/O interface unit 16 and communication control apparatus 17 are connected via bus 18.

Processing apparatus 10 realizes the functions of threshold judging unit 21, resource information collecting unit 23, virtual server moving unit 24 and autonomous disposition control unit 22 in accordance with the program recorded in recording medium 13. Recording medium 13 may be a magnetic disc, a semiconductor memory, an optical disc or the other recording medium.

In the meantime, autonomous control server 2 is not limited to a computer. For example, the autonomous control server may be a structure that realizes the functions of threshold judging unit 21, resource information collecting unit 23, virtual server moving unit 24 and autonomous disposition control unit 22 by using a semiconductor integrated circuit apparatus such as LSI (Large Scale Integration) or DSP (Digital Signal Processor) consisting of a logic circuit and the like, a memory and the like, in addition to communication control apparatus 17 that is an interface with communication network 1.

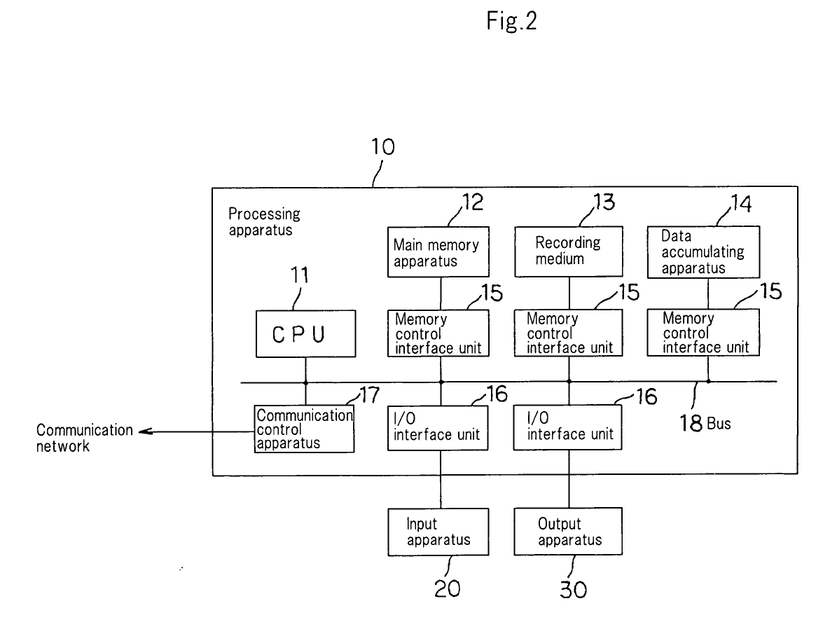

Physical servers 3₁˜3ₘ may be also realized with the same structure as autonomous server 2 shown in FIG. 2, except that the program stored in recording medium 13 and the data stored in data accumulating apparatus 14 are different.

According to the present invention, by calculating the evaluation value that is an index to level the utilization rate of resources of each physical server after the virtual servers move, and by determining a virtual server that is to be moved or a destination physical server from the moving candidate having the lowest evaluation value or the highest evaluation value, a difference of the utilization rates of resources of the original physical servers and the destination physical servers is reduced and the utilization rates of resources are leveled. Hence, it is possible to efficiently dispose the plurality of virtual servers on the plurality of physical servers and to concentrate the resource utilization on each physical server within a range that does not exceed the high load threshold value.

Further, since the plurality of virtual servers are disposed on the physical servers in such a way that the utilization rate of resources does not exceed the high load threshold value, it is possible to efficiently utilize the vacant resources in the other physical servers, which resources correspond to an extent that the virtual servers are not disposed on the corresponding physical servers.

### First Exemplary Embodiment

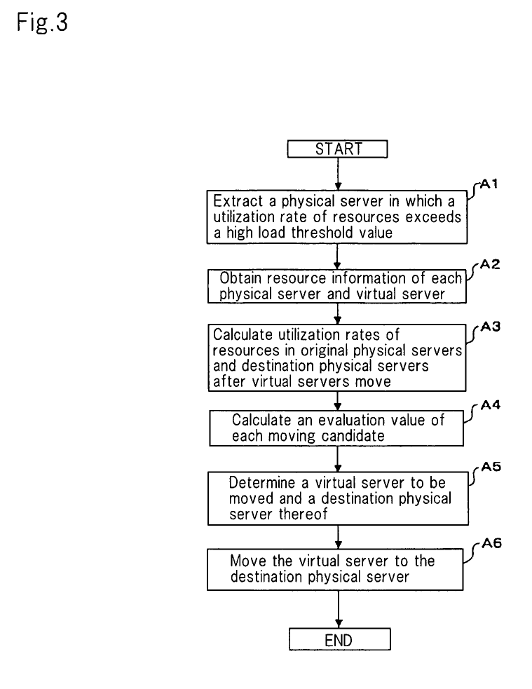

In the followings, an operation of a first exemplary embodiment of the virtual server system shown in FIG. 1 will be described with reference to FIG. 3.

FIG. 3 is a flow chart showing procedures of a first exemplary embodiment of an autonomous control server provided to the virtual server system shown in FIG. 1.

The virtual server system of a first exemplary embodiment relates to an example in which when a utilization rate of resources in any physical server exceeds a preset high load threshold value, a virtual server operating on the corresponding physical server is moved to level the utilization rates of resources of the respective physical servers. Hereinafter, such a process is referred to as distribution of the virtual servers. The first exemplary embodiment, exemplifies that the utilization rate of resources in physical server 3₁ exceeds the high load threshold value and the virtual server 3₁₁ operating on physical server 3₁ is moved to physical server 3ₘ.

It is assumed that autonomous control server 2 has already obtained the resource information of physical servers 3₁˜3ₘ and virtual servers 3₁₁˜3ₘₙ through resource information collecting unit 23.

As shown in FIG. 3, autonomous control server 2 compares the utilization rate of resources and a preset high load threshold value by threshold judging unit 21, based on the resource information obtained in resource information collecting unit 23, and notifies evaluation value calculating unit 221 of autonomous disposition control unit 22 of information of a physical server in which the utilization rate of resources exceeds the high load threshold value (step A1).

Evaluation value calculating unit 221 obtains the resource information of virtual servers 3₁₁˜3ₘₙ operating on physical server 3₁ notified from threshold judging unit 21 and physical serves 3₁˜3ₘ from resource information collecting unit 23 (step A2).

In addition, evaluation value calculating unit 221 calculates an evaluation value for determining a virtual server that is to be moved and a destination physical server thereof by using the capacity information of physical servers 3₁˜3ₘ stored in physical server static information memory unit 222 and the resource information of physical servers 3₁˜3ₘ and virtual servers 3₁₁˜3ₘₙ obtained from resource information collecting unit 23. At this time, evaluation value calculating unit 221 excludes physical server 3₁, in which the utilization rate of resources exceeds the high load threshold value, from the evaluation objects.

In the evaluation value calculation, the utilization rates of resources of the original physical servers and destination physical servers after a virtual server is moved are respectively calculated (step A3).

The utilization rates of resources of the original physical servers and destination physical servers after the virtual server is moved, i.e., U′(SV_{src}, VM, R) and U′(SV_{dest}, VM, R) are respectively calculated by using the below equation (1).

$$\begin{matrix}[ Equation 1 ] & \\ {U}^{′} ( S {V}_{src} , V M , R ) = U ( S {V}_{src} , R ) - U ( S {V}_{src} , V M , R ) \\ {U}^{′} ( S {V}_{dest} , V M , R ) = U ( S {V}_{dest} , R ) + U ( S {V}_{src} , V M , R ) \cdot \frac{C ( S {V}_{src} , R )}{C ( S {V}_{dest} , R )} & \end{matrix}$$

where SV_{dest} denotes a destination physical server, SV_{src} denotes the original physical server to where a virtual server is to be moved, VM denotes a virtual server, R denotes a resource, U(SV, R) denotes a utilization rate of resources of a physical server, C(SV, R) denotes a resource capacity of SV, and U(SV, VM, R) denotes a utilization rate (%) of resources of a virtual server operating on a physical server.

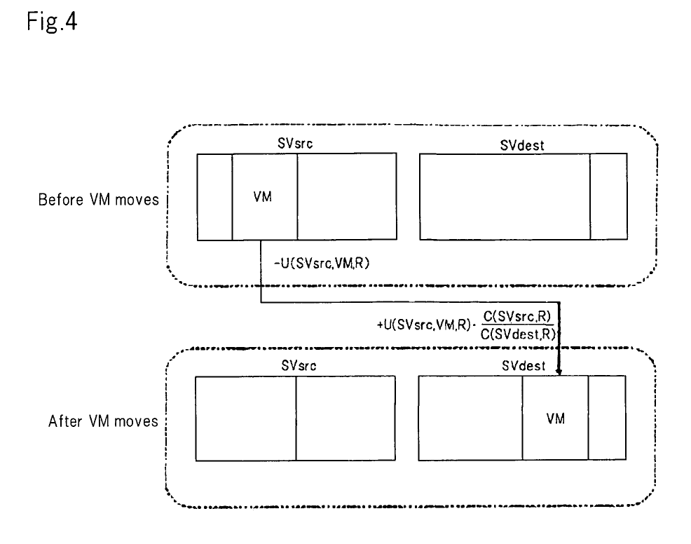

FIG. 4 shows that utilization rates of resources of each physical server are changed before and after a virtual server (VM) is moved. FIG. 4 shows that the utilization rate of resources in original physical server SV_{src} is decreased (−U(SV_{src}, VM, R)), and the utilization rate of resources in destination physical server SV_{dest} is increased (+U(SV_{src}, VM, R)·C(SV_{src}, R)/C(SV_{dest}, R). The utilization rate of resources in destination physical server 3 can be calculated from the utilization rate of resources of a virtual server to be moved and a ratio of the capacity information of the original physical servers and the destination physical servers to where the virtual servers move.

Subsequently, with respect to moving candidates comprised of all combinations of virtual servers 3₁₁˜3₁ₙ operating on physical server 3₁, which has been notified from threshold judging unit 21 in the step A1, and physical servers 3₂˜3ₘ to where the virtual servers move, evaluation value calculating unit 221 calculates an evaluation value, respectively (step A4).

At this time, it is important to consider how the utilization rates of resources of the original physical servers and the destination physical servers are changed as virtual server 3₁₁ moves. To this end, it is preferable to define an evaluation value so that the utilization rates of resources of the original physical servers and the destination physical servers are approximately same. Here, a variance of the utilization rates of resources of two physical servers SVₐ, SV_{b} after the virtual server moves can be defined with a following equation (2).

$$\begin{matrix}[ Equation 2 ] & \\ V ( S {V}_{a} , S {V}_{b} , V M , R ) = {\{ {U}^{′} ( S {V}_{a} , V M , R ) - \overline{U} ( V M , R ) \}}^{2} + {\{ {U}^{′} ( S {V}_{b} , V M , R ) - \overline{U} ( V M , R ) \}}^{2} \\ \overline{U} ( V M , R ) = \frac{{U}^{′} ( S {V}_{a} , V M , R ) + {U}^{′} ( S {V}_{b} , V M , R )}{2} & ( 2 )\end{matrix}$$

In addition, since the physical server has a plurality of resources, the evaluation value is defined with the following equation (3), considering a weighting w (R) for each resource R.

$$\begin{matrix}[ Equation 3 ] & \\ f ( S {V}_{a} , S {V}_{b} , V M ) = {\sum }_{Re \{ CPU , Memory , Network I / O , HDD I / O} w ( R ) \cdot V ( S {V}_{a} , S {V}_{b} , V M , R ) & ( 3 )\end{matrix}$$

where, weighting w (R) is an index to lay stress on each item of resource information and is assumed to be already registered in data accumulating apparatus 14 and the like.

Evaluation value calculating unit 221 calculates evaluation values of each combination of virtual servers to be moved and the destination physical servers thereof after the virtual server moves in accordance with the equation 3, and determines a virtual server, that is to be moved and the destination physical server thereof, based on the calculated evaluation values of each combination (step A5). In this exemplary embodiment, since it is aimed at leveling the utilization rates of resources of the original physical servers and the destination physical servers, a combination of a virtual server and a physical server which is the destination thereof that has the lowest evaluation value and to where the virtual server is to be moved is selected.

Finally, autonomous control server 2 moves the virtual server (for example, virtual server 3₁₁) determined in the process of step A5 by evaluation value calculating unit 221 to the destination physical server (for example, physical server 3ₘ) by using virtual server moving unit 24 (step A6).

According to the virtual server system of this exemplary embodiment, when the utilization rate of resources in any physical server exceeds a preset high load threshold value, a virtual server is moved to another physical server in which the utilization rate of resources is relatively low, so that the utilization rates of resources of the respective physical servers can be leveled.

### Second Exemplary Embodiment

The second exemplary embodiment relates to an example where when the utilization rate of resources in any physical server is lower than a preset low load threshold value, a virtual server operating on another physical server is moved to the corresponding physical server. Hereinafter, such process is referred to as consolidation of virtual servers.

Since the object of this exemplary embodiment is consolidating the utilization of resources in a physical server which is the destination server to where the virtual server is to be moved, this exemplary embodiment is different from the virtual server system of the first exemplary embodiment shown in FIG. 3, in that information of a physical server in which the utilization rate of resources is lower than a low load threshold value is notified to evaluation value calculating unit 221 of autonomous disposition control unit 22 from threshold judging unit 21 in the step A1, and a combination of a virtual server and an original physical server thereof that has the highest evaluation value is selected and to where the virtual server is to be moved from the determined original physical server in the step A4. Since the structures and the other procedures of the virtual server system are same as those of the first exemplary embodiment, the descriptions thereof will be omitted.

According to the virtual server system of this exemplary embodiment, when the utilization rate of resources in any physical server is lower than a preset low load threshold value, a virtual server is moved from the other physical server in which the utilization rate of resources is relatively high. Thus, it is possible to increase the utilization efficiency of the corresponding physical server.

### Third Exemplary Embodiment

The third exemplary embodiment relates to an example where when the utilization rate of resources in any physical server exceeds a preset high load threshold value, a plurality of virtual servers operating on the corresponding physical server are moved at the same time, thereby leveling the utilization rates of resources in the respective physical servers.

The third exemplary embodiment, exemplifies that the utilization rate of resources in physical server 3₁ exceeds a high load threshold value and that virtual servers 3₁₁, 3₁ₙ operating on physical server 3₁ are moved to physical server 3ₘ. The number of the virtual servers that are moved at the same time is not limited to two, and three or more virtual servers may be moved.

The structures and the procedures of the virtual server system of the third exemplary embodiment are basically same as those of the first exemplary embodiment.

However, in the third exemplary embodiment, the utilization rate of resources in the original physical server after the virtual servers moves, i.e., U′(SV_{src}, VM, R), and the utilization rate of resources in the destination physical server, i.e., U′(SV_{dest}, VM, R) are calculated with a following equation (4) in the step A3.

$$\begin{matrix}[ Equation 4 ] & \\ {U}^{′} ( S {V}_{src} , V {M}^{*} , R ) = U ( S {V}_{src} , R ) - U ( S {V}_{src} , V {M}^{*} , R ) \\ {U}^{′} ( {SV}_{dest} , V {M}^{*} , R ) = U ( S {V}_{dest} , R ) + U ( S {V}_{src} , V {M}^{*} , R ) \cdot \frac{C ( S {V}_{src} , R )}{C ( S {V}_{dest} , R )} & ( 4 )\end{matrix}$$

where VM* denotes a plurality of virtual servers.

When a plurality of virtual servers are moved at the same time, the utilization rate of resources in original physical server SV_{src} is decreased (−U(SV_{src}, VM*, R)) and the utilization rate of resources in destination physical server SV_{dest} is increased (+U(SV_{src}, VM*, R)·C(SV_{src}, R)/C(SV_{dest}, R). The utilization rate of resources in destination physical server 3 can be calculated from the utilization rates of resources in the moving virtual servers and a ratio of the capacity information of the original physical servers and destination physical servers.

With respect to moving candidates comprised of all combinations of virtual servers 3₁₁, 3₁ₙ, which operate on physical server 3₁ notified from threshold judging unit 21 in the step A1, and physical servers 3₂˜3ₘ which are the destination servers, evaluation value calculating unit 221 calculates evaluation values, respectively, in the step A4.

The evaluation value is defined so that the utilization rates of resources in the original physical servers and destination physical servers are approximately same, likewise the first exemplary embodiment. Here, a variance of the utilization rates of resources in two physical servers SVₐ, SV_{b} after the virtual servers move can be defined with the following equation (5).

$$\begin{matrix}[ Equation 5 ] & \\ V ( S {V}_{a} , S {V}_{b} , V {M}^{*} , R ) = {\{ {U}^{′} ( S {V}_{a} , V {M}^{*} , R ) - \overline{U} ( V {M}^{*} , R ) \}}^{2} + {\{ {U}^{′} ( S {V}_{b} , V {M}^{*} , R ) - \overline{U} ( V {M}^{*} , R ) \}}^{2} \\ \overline{U} ( V {M}^{*} , R ) = \frac{{U}^{′} ( S {V}_{a} , V {M}^{*} , R ) + {U}^{′} ( S {V}_{b} , V {M}^{*} , R )}{2} & ( 5 )\end{matrix}$$

In addition, since the physical server has a plurality of resources, an evaluation value is defined with the following equation (6), taking into consideration a weighting w(R) for each resource R.

$$\begin{matrix}[ Equation 6 ] & \\ f ( S {V}_{a} , S {V}_{b} V {M}^{*} ) = {\sum }_{Re \{ CPU , Memory , Network I / O , HDD I / O} w ( R ) \cdot V ( S {V}_{a} , S {V}_{b} , V {M}^{*} , R ) & ( 6 )\end{matrix}$$

The weighting w(R) is an index to lay stress on each item of resource information and is assumed to be already registered in data accumulating apparatus 14 and the like.

Evaluation value calculating unit 221 calculates evaluation values of each combination of the virtual servers to be moved and the physical servers that are the destination servers after the virtual servers move in accordance with the equation (6) and determines virtual servers to be moved and physical servers that are the destination servers thereof, based on the calculated evaluation values of each combination, in the step A5.

Since this exemplary embodiment, is aimed at leveling the utilization rates of resources in the original physical servers and the destination physical servers, a combination of a virtual server and a destination physical server having the lowest evaluation value is selected.

Finally, autonomous control server 2 moves virtual servers (for example, virtual servers 3₁₁, 3₁ₙ), which are determined by evaluation value calculating unit 221 in the process of step A5, to the destination physical server (for example, physical server 3ₘ) by using virtual server moving unit 24 (step A6).

In the meantime, the above description has exemplified a case where when the utilization rate of resources in any physical server exceeds a preset high load threshold value, a plurality of virtual servers operating on the corresponding physical server are moved at the same time to level the utilization rates of resources in the respective physical servers, as in the first exemplary embodiment. However, this exemplary embodiment can also be applied to a case where when the utilization rate of resources in any physical server is lower than a preset low load threshold value, a virtual server operating on another physical server is moved to the corresponding physical server to consolidate the load of resources in the destination physical server, as in the second exemplary embodiment.

According to the third exemplary embodiment, since the plurality of virtual servers are moved to another physical server at the same time, it is possible to level the utilization rates of resources in the respective physical servers by one virtual server distributed processing.

### Fourth Exemplary Embodiment

In the first exemplary embodiment, a virtual server to be moved is determined on the basis of the current utilization rate of resources. The fourth exemplary embodiment relates to an example where an estimate value of the utilization rate of resources, which is a result of estimating a future utilization rate of resources from a current utilization rate of resources and a past utilization rate of resources, is used to determine a virtual server to be moved. The estimate value of the utilization rate of resources is a value to analyze a variation result of past utilization rates of resources to estimate a utilization rate of resources after a virtual server moves. The estimate value of the utilization rate of resources can be calculated by using an average value of the utilization rates of resources or an autoregressive model. However, the invention is not limited to a specific method.

In the meantime, the fourth exemplary embodiment illustrates an example where virtual server 3₁₁ operating on physical server 3₁ in which the utilization rate of resources is estimated to be increased is moved to physical server 3ₘ.

The structures and procedures of the virtual server system of the fourth exemplary embodiment are basically same those of the first exemplary embodiment.

However, in the fourth exemplary embodiment, an estimate value of the utilization rate of resources in the original physical server after a virtual server moves, i.e.,

Û′(SV_{src},VM,R) [Equation 7]

and an estimate value of the utilization rate of resources of a destination physical server, i.e.,

Û′(SV_{dest},VM,R) [Equation 8]

are calculated by a following equation (7) in the step of A3.

$$\begin{matrix}[ Equation 9 ] & \\ {\hat{U}}^{′} ( S {V}_{src} , V {M}^{*} , R ) = \hat{U} ( S {V}_{src} , R ) - \hat{U} ( S {V}_{src} , V {M}^{*} , R ) \\ {\hat{U}}^{′} ( S {V}_{dest} , V {M}^{*} , R ) = \hat{U} ( S {V}_{dest} , R ) + \hat{U} ( S {V}_{src} , V {M}^{*} , R ) \cdot \frac{C ( S {V}_{src} , R )}{S ( S {V}_{dest} , R )} & ( 7 )\end{matrix}$$

where,

Û′(SV_{src},VM,R) [Equation 10]

and

Û(SV_{dest},VM,R) [Equation 11]

indicate estimate values (%) of the utilization rates of resources of virtual servers operating on the physical server.

When a virtual server is moved, the utilization rate of resources in original physical server SV_{src} is decreased (−U(SV_{src}, VM, R)) and the utilization rate of resources in destination physical server SV_{dest} is increased (+U(SV_{src}, VM, R)·C(SV_{src}, R)/C(SV_{dest}, R). The estimate value of the utilization rate of resources in the destination physical server can be calculated from the estimate values of the utilization rate of resources in the virtual servers to be moved and a ratio of the capacity information of the original physical servers and the destination physical servers.

With respect to moving candidates comprised of all combinations of virtual servers 3₁₁˜3₁ₙ, which are operated on physical server 3₁ notified from threshold judging unit 21 in the step A1, and physical servers 3₂˜3ₘ which are the destination servers, evaluation value calculating unit 221 calculates evaluation values, respectively.

The evaluation value is defined so that the utilization rates of resources in the original physical servers and the destination physical servers are approximately same, as in the first exemplary embodiment. Here, a variance of the utilization rates of resources in two physical servers SVₐ, SV_{b} after the virtual servers move can be defined with the following equation (8).

$$\begin{matrix}[ Equation 12 ] & \\ V ( S {V}_{a} , S {V}_{b} , V M , R ) = {\{ {\hat{U}}^{′} ( S {V}_{a} , V M , R ) - \overline{U} ( V M , R ) \}}^{2} + {\{ {\hat{U}}^{′} ( S {V}_{b} , V M , R ) - \overline{U} ( V M , R ) \}}^{2} \\ \overline{U} ( V M , R ) = \frac{{U}^{′} ( S {V}_{a} , V M , R ) + {U}^{′} ( S {V}_{b} , V M , R )}{2} & ( 8 )\end{matrix}$$

In addition, since the physical server has a plurality of resources, an evaluation value is defined with a following equation (9), taking into consideration a weighting w(R) for each resource R.

$$\begin{matrix}[ Equation 13 ] & \\ f ( S {V}_{a} , S {V}_{b} V M ) = {\sum }_{Re \{ CPU , Memory , Network I / O , HDD I / O} w ( R ) \cdot V ( S {V}_{a} , S {V}_{b} , V M , R ) & ( 9 )\end{matrix}$$

The weighting w(R) is an index to lay stress on each item of resource information and is assumed to be already registered in data accumulating apparatus 14 and the like.

Evaluation value calculating unit 221 calculates evaluation values of each combination of the virtual servers to be moved and the destination physical servers after the virtual servers move in accordance with the equation (8) and determines a virtual server to be moved and the destination physical server, based on the calculated estimates values of each combination, in the step A5.

Since this exemplary embodiment, since it is aimed at leveling the utilization rates of resources in the original physical servers and the destination physical servers, it is selected a combination of a virtual server and a destination physical server thereof having the lowest evaluation value.

Finally, autonomous control server 2 moves virtual servers (for example, virtual servers 3₁₁, 3₁ₙ), which are determined by evaluation value calculating unit 221 in the process of step A5, to the destination physical server (for example, physical server 3ₘ) by using virtual server moving unit 24 (step A6).

In the meantime, the above description has exemplified a case where when the utilization rate of resources in any physical servers exceeds a preset high load threshold value, a plurality of virtual server operating on the corresponding physical server are moved to level the utilization rates of resources in the respective physical servers, as in the first exemplary embodiment. However, this exemplary embodiment can be also applied to a case where when the utilization rate of resources in any physical server is lower than a preset low load threshold value, a virtual server operating on another physical server is moved to the corresponding physical server to consolidate the load of resources in the destination physical server, as in the second exemplary embodiment. Further, this exemplary embodiment can be applied to the case where a plurality of virtual serves are moved at the same time, by using the estimate values of the utilization rates of resources, as in the third exemplary embodiment.

According to the fourth exemplary embodiment, based on an estimate value (variation estimating result) of estimating a future utilization rate of resources from a past utilization rate of resources, the load variation thereof is estimated in order to select a destination physical server.

This application claims the priority of Japanese Patent Application No. 2007-043563 filed on Feb. 23, 2007, the disclosures of which are incorporated herein by reference.

1. A virtual server system comprising:
a plurality of physical servers on each of which a plurality of virtual servers operate; and
an autonomous control server that is connected to said physical servers by a communication network,
wherein said autonomous control server extracts a physical server in which a utilization rate of resources exceeds a high load threshold value by using resource information of said physical servers and said virtual servers and capacity information of said physical servers, said capacity information indicating a performance value of said physical server and said high load threshold value being the preset upper limit of a utilization rate for each resource;
with respect to moving candidates comprised of all combinations of a plurality of virtual servers operating on the extracted physical server and physical servers to where said virtual servers move, calculates an evaluation value that is an index to level the utilization rates of resources of each physical server after preset virtual servers move;
determines a virtual server, that is to be moved and a destination physical server thereof to where said virtual sever moves, from the moving candidate having the lowest evaluation value; and
moves the determined virtual server to said destination physical server.

2. A virtual server system comprising:
a plurality of physical servers on each of which a plurality of virtual servers operate; and
an autonomous control server that is connected to said physical servers by a communication network,
wherein said autonomous control server extracts a physical server in which a utilization rate of resources is lower than a low load threshold value by using resource information of said physical servers and said virtual servers and capacity information of said physical servers, said capacity information indicating a performance value of said physical server and said low load threshold value being the preset lower limit of a utilization rate for each resource;
with respect to moving candidates comprised of all combinations of a plurality of virtual servers to be moved to the extracted physical server and original physical servers to where said virtual servers are to be moved, calculates an evaluation value that is an index to level the utilization rates of resources of each physical server after preset virtual servers move;
determines a virtual server to be moved and an original physical server thereof to where said virtual server is to be moved from the moving candidate having the highest evaluation value; and
moves said virtual server from the determined original physical server.

3. The virtual server system according to claim 1, wherein an estimate value is used as said utilization rate of resources, the estimate value being a result of estimating a future utilization rate of resources from a current utilization rate of resources of the current state and a past utilization rate of resources.

4. A method of selecting a physical server on which a plurality of virtual servers are disposed,
wherein a computer:
extracts said physical server in which a utilization rate of resources exceeds a high load threshold value by using resource information of said physical server and said virtual servers and capacity information of said physical server, said capacity information indicating a performance value of said physical server and said high load threshold value being the preset upper limit of a utilization rate for each resource;
with respect to moving candidates comprised of all combinations of a plurality of virtual servers operating on the extracted physical server and physical servers to where said virtual servers move, calculates an evaluation value that is an index to level the utilization rates of resources of each physical server after preset virtual servers move;
determines a virtual server to be moved and a destination physical server thereof to where said virtual sever moves from the moving candidate having the lowest evaluation value; and
moves the determined virtual server to said destination physical server.

5. A method of selecting a physical server on which a plurality of virtual servers are disposed,
wherein a computer:
extracts said physical server in which a utilization rate of resources is lower than a low load threshold value by using resource information of said physical server and said virtual servers and capacity information of said physical server, said capacity information indicating a performance value of said physical server and said low load threshold value being the preset lower limit of a utilization rate for each resource;
with respect to moving candidates comprised of all combinations of a plurality of virtual servers to be moved to the extracted physical server and original physical servers to where said virtual servers are to be moved, calculates an evaluation value that is an index to level the utilization rates of resources of each physical server after preset virtual servers move;
determines a virtual server to be moved and an original physical server thereof to where said virtual server is to be moved from the moving candidate having the highest evaluation value; and
moves said virtual server from the determined original physical server.

6. The method according to claim 4, wherein an estimate value is used as said utilization rate of resources, the estimate value being a result of estimating a future utilization rate of resources from a current utilization rate of resources of the current state and a past utilization rate of resources.

7. The virtual server system according to claim 2, wherein an estimate value is used as said utilization rate of resources, the estimate value being a result of estimating a future utilization rate of resources from a current utilization rate of resources of the current state and a past utilization rate of resources.

8. The method according to claim 5, wherein an estimate value is used as said utilization rate of resources, the estimate value being a result of estimating a future utilization rate of resources from a current utilization rate of resources of the current state and a past utilization rate of resources.
